(19) United States
(12) Patent Application Publication
(10) Pub. No.: US 2025/0249375 A1
(43) Pub. Date: Aug. 7, 2025

(54) RACE START JUDGING DEVICE

(71) Applicant: TOYOTA JIDOSHA KABUSHIKI KAISHA, Aichi-ken (JP)

(72) Inventor: Naoya INOUE, Nagoya-shi (JP)

(21) Appl. No.: 19/034,557

(22) Filed: Jan. 23, 2025

(30) Foreign Application Priority Data
Feb. 1, 2024 (JP) 2024-014387

(51) Int. Cl. A63K 3/02; A63B 71/06; G07C 1/22

(52) U.S. Cl. CPC A63K 3/02; A63B 71/0616; G07C 1/22

(57) ABSTRACT

The race start preparation judging unit judges that the racing vehicle is within a predetermined range from the race start position based on the race start position information indicating the race start position included in the course information, the vehicle position information of the racing vehicle obtained by the vehicle position acquiring unit, and the vehicle speed information obtained by the traveling data acquiring unit. When it is judged that the racing vehicle has stopped, the race start judging unit judges that the racing vehicle has stopped at the race start position. The race start judging unit identifies the point in time at which the racing vehicle has departed after the race start preparation judging unit judges that the racing vehicle has stopped at the race start position as the point in time at which the race in which the racing vehicle participates begins.

### CROSS REFERENCE TO RELATED APPLICATION

This application claims priority to Japanese Patent Application No. 2024-014387 filed on Feb. 1, 2024, which is incorporated herein by reference in its entirety including the specification, claims, drawings, and abstract.

### TECHNICAL FIELD

The present disclosure relates to improvements to race start judging device.

### BACKGROUND

Conventionally, a system for acquiring information on the running of a racing vehicle, which is a vehicle participating in a race, during a motor sports competition race is provided. For example, Patent literature 1 discloses a system that calculates an offset representing the deviation between the lap time of a racing vehicle and a predetermined reference lap time, and calculates the position of the racing vehicle on the racing course based on the elapsed time since the racing vehicle passed a reference point on the racing course and the calculated offset.

### CITATION LIST

PATENT LITERATURE 1: JP2007-233462A

By the way, consider judging the start of a race (in detail, the starting point of a race) in a motor sports competition. By judging the start of a race, for example, it is possible to start recording various travel data (e.g., time and maximum speed) related to the racing vehicle's travel in the race from the start of the race. Usually, the circuit where the race is held has a system linked to the start signal that notifies the driver of the start of the race, and the start of the race is judged by this system.

However, such systems are owned by the circuit management. Therefore, when a race operator who uses the circuit to conduct a race needs to use such a system, he/she needs to obtain permission from the circuit administrator or pay a fee to the circuit administrator for the use of the system.

Therefore, it would be desirable to be able to judge the start of a race without using the system provided at the circuit.

Generally, just before the start of a race, racing vehicles participating in the race stop at a predetermined race start position. After the racing vehicle has stopped at the race start position, the vehicle starts according to the start signal.

In this case, it would be desirable to be able to judge easily that the racing vehicle has stopped at the race start position and that the racing vehicle is ready to start the race before the race starts.

The purpose of the race start judging device disclosed herein is to enable judging the start of a race without using a system provided at a circuit. Alternatively, the purpose of the race start judging device disclosed herein is to make it possible to easily judge that a racing vehicle is ready to start a race before the race starts.

### SUMMARY

A race start judging device disclosed in the present specification comprising:
a vehicle position acquiring unit that acquires vehicle position information indicating a position of a racing vehicle participating in a race;
a vehicle speed acquiring unit that acquires vehicle speed information indicating a vehicle speed of the racing vehicle; and
a race start judging unit that judges that the race has started upon detecting that the racing vehicle has departed from a vicinity of a race start position based on race start position information indicating the race start position at which the racing vehicle is to start the race, the vehicle position information, and the vehicle speed information.

A race start judging device disclosed in the present specification may be further comprising a race start preparation judging unit that judges that the racing vehicle is prepared to start a race upon detecting that the racing vehicle is within a predetermined range from the race start position based on the race start position information and the vehicle position information, and upon further detecting that the racing vehicle is stopped based on the vehicle speed information, and

The race start judging unit may judge that the race has started when it detects that the racing vehicle has departed based on the vehicle speed information after the race start readiness judging unit has determined that the racing vehicle is ready to start the race.

Also a race start judging device disclosed in the present specification comprising:
a vehicle position acquiring unit that acquires vehicle position information indicating a position of a racing vehicle participating in a race;
a vehicle speed acquiring unit that acquires vehicle speed information indicating s vehicle speed of the racing vehicle; and
a race start preparation judging unit that judges that the racing vehicle is prepared to start a race upon detecting that the racing vehicle is within a predetermined range from a race start position based on race start position information indicating the race start position at which the racing vehicle is to start the race and the vehicle position information, and upon further detecting that the racing vehicle is stopped based on the vehicle speed information.

According to the race start judging device disclosed herein, it is possible to judge the start of a race without using a system provided at a circuit. Alternatively, the race start judging device disclosed herein can easily judge that a racing vehicle is ready to start a race before the race starts.

### BRIEF DESCRIPTION OF DRAWINGS

Embodiment of the present disclosure will be described based on the following figures, wherein:

FIG. 1 is schematic diagram of the judging system.

FIG. 2 is conceptual diagram shows an example of the contents of course information.

FIG. 3 shows examples of the start line, finish line, and grid.

FIG. 4 is schematic diagram of the configuration of the judging device.

FIG. 5 shows the parameters used in the calculation to judge that a racing vehicle has stopped on the grid.

FIG. 6 shows the process flow of the judging system.

### EMBODIMENTS

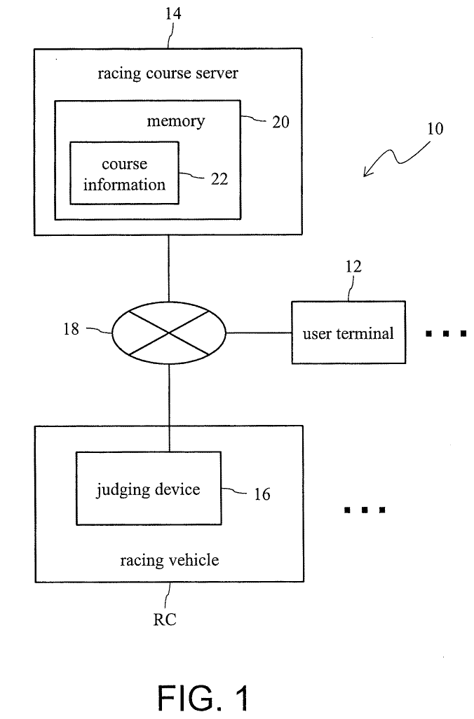

FIG. 1 is a schematic diagram of a judging system 10 for racing vehicles. The judging system 10 comprises a user terminal 12, a racing course server 14, and a judging device 16 provided in a racing vehicle RC participating in a race as a race start judging device or a race start preparation judging device. The racing course server 14, the user terminal 12, and the judging device 16 are communicatively connected to each other via a communication line 18 such as the Internet or wireless communication.

The racing vehicle RC is not limited to a racing-specific vehicle such as, for example, an F1 car. In the past, races in which commercially available general vehicles can participate have also been held, and general vehicles participating in such races are also included in racing vehicles RCs. The racing vehicle RC is not limited to a four-wheeled vehicle, but may also be a two-wheeled vehicle. Furthermore, the racing vehicle RC may have any type of prime mover, and the racing vehicle RC may be a vehicle without a prime mover.

The user terminal 12 is a terminal used by a user such as a driver of the racing vehicle RC or a staff member of a racing team. The user terminal 12 may be, for example, a smartphone or a PC.

The racing course server 14 comprises, for example, a server computer. The memory 20 of the racing course server 14 stores course information 22 concerning the racing course to be managed.

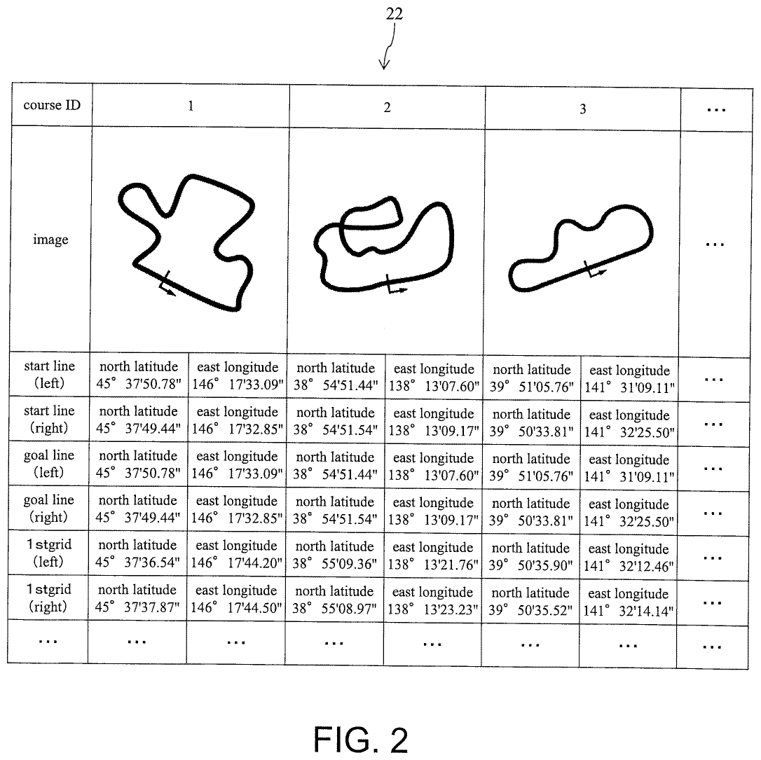

FIG. 2 is a conceptual diagram showing the contents of the course information 22. The course information 22 includes a course ID uniquely identifying the course, an image showing the layout of the course, and location information showing the start line, goal line, and the location of each grid. In the example in FIG. 2, each course is a lap course, but a course is not limited to a lap course. For example, it can be a non-loop course, such as a rally course.

Course information 22 may have not only an image of the course, but also location information indicating the layout of each course. For example, it may have location information indicating the position of each corner that the course has and information indicating the order in which each corner is passed.

In this system, the position information indicating the location of the start line, finish line, and each grid is expressed in polar coordinates such as latitude and longitude (or even height). Start line (left) means one end of the start line, and start line (right) means the other end of the start line. In other words, in this system, the starting line is represented by the polar coordinates of one end and the polar coordinates of the other end. The same applies to the goal line and the grid.

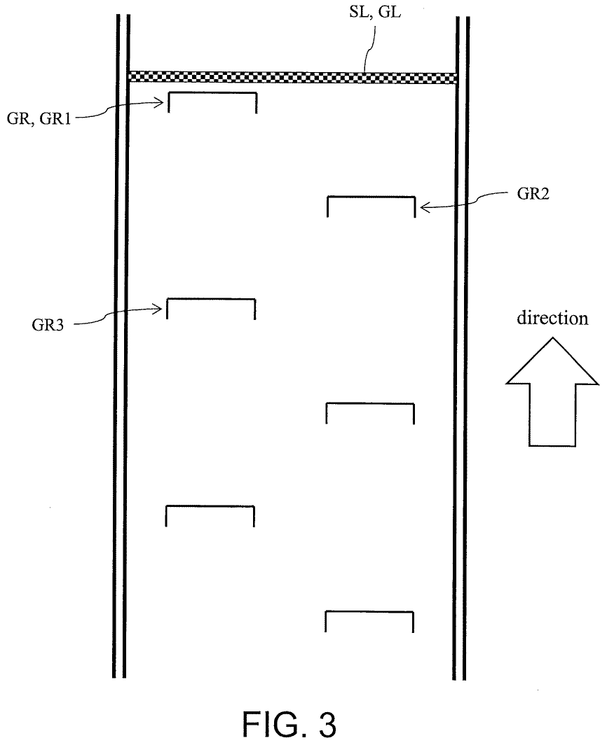

FIG. 3 shows examples of the start line SL, goal line GL, and grid GR. For example, in a race format where each racing vehicle RC starts sequentially, the start line SL is the position where the racing vehicle RC should start the race, the race start position. In this case, the position information indicating the position of the start line SL is the race start position information. In the lap course, the start line SL is the reference line for measuring the lap time (the time required for the racing vehicle RC to complete one lap of the course). In this case, the start line SL is also called the control line. The goal line GL is the line that marks the goal position of the course. As shown in FIG. 3, in a circuit course, the start line SL and the goal line GL are generally in the same position. In a non-loop course, the start line SL and the goal line GL are in different positions.

A plurality of grids GR are provided behind the start line SL. In this specification, the side of the racing vehicle RC on the course in the direction of travel is described as “front” and the opposite side is described as “rear. A plurality of grids GR are provided in line in the direction of travel of the racing vehicle RC on the course. As shown in FIG. 3, generally, two rows of grids GR are provided, for example, in order of proximity from the starting line SL: first grid GR1 (first front of the first row), second grid GR2 (first front of the second row) diagonally behind it, third grid GR3 (second of the first row) diagonally behind it, and so on . . . (2) Start line Generally, the first grid GR1 closest to the starting line SL is provided in the row inside the first corner of the course (on the direction of the turn at the first corner).

In a race in which a plurality of racing vehicles start simultaneously from a stationary position (standing start), each grid GR is the starting position of the race for each racing vehicle RC. In this case, the position information indicating the position of each grid GR becomes the race start position information for each racing vehicle RC. Which grid GR is the race start position for each racing vehicle RC is determined, for example, by the qualifying race held prior to the race. For example, the racing vehicle RC with a higher ranking in the qualifying race will start the race on a grid GR that is closer to the first grid GR1. Or, there is a reverse grid system in which the racing vehicle RC with a lower ranking in the qualifying race will start the race on a grid GR that is closer to the first grid GR1.

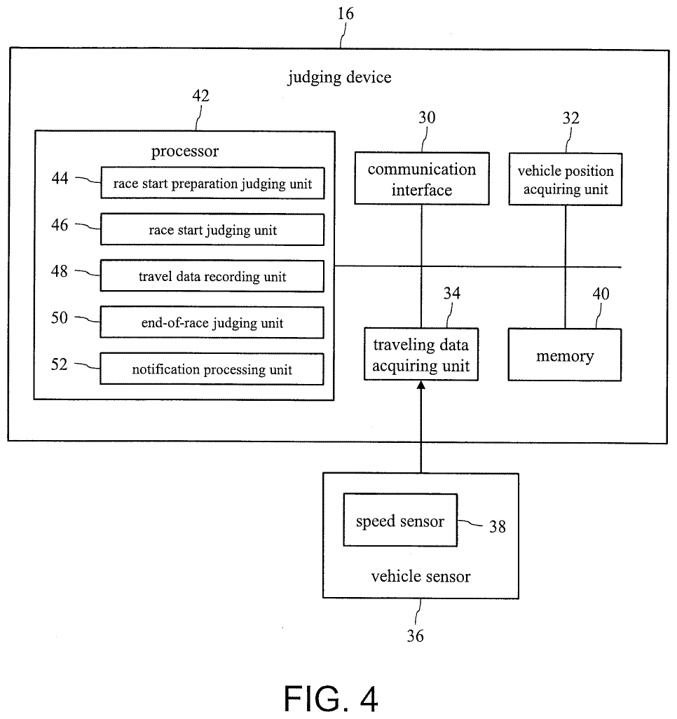

FIG. 4 is a schematic diagram of the judging device 16. In this embodiment, the judging device 16 is mounted on the racing vehicle RC.

The communication interface 30 comprises, for example, a network adapter. The communication interface 30 functions to communicate with the user terminal 12 and the racing course server 14.

The vehicle position acquiring unit 32 comprises, for example, an antenna for receiving radio waves from a GNSS (Global Navigation Satellite System) satellite and a receiver for processing the received signals. The vehicle position acquiring unit 32 acquires vehicle position information indicating the position of the racing vehicle RC based on the reception timing of radio waves from multiple GNSS satellites. The vehicle position acquiring unit 32 obtains the vehicle position information intermittently. For example, the vehicle position acquiring unit 32 acquires vehicle position information at a frequency of about 20 Hz (about 20 times per second). In this embodiment, the vehicle position information is expressed in polar coordinates, similar to the positions of the start line SL and grid GR in the course information 22. The acquired vehicle position information is stored in the memory 40 described below.

The traveling data acquiring unit 34 comprises, for example, a connector to which a cable from the vehicle sensor 36 is connected, or a short-range wireless communicator that performs short-range wireless communication with the vehicle sensor 36. The traveling data acquiring unit 34 acquires driving data, which is the detection data of the vehicle sensor 36. The racing vehicle RC is provided with various vehicle sensor 36. The vehicle sensor 36 include various sensors such as an on-board camera, sensors that detect the amount of gas pedal and brake operation, sensors that detect the amount of steering wheel (steering wheel) operation, or sensors that detect gear status and the like. In particular, the vehicle sensor 36 includes a speed sensor 38 that detects the speed of the racing vehicle RC. The traveling data acquiring unit 34 acquires, as one of the driving data, vehicle speed information indicating the vehicle speed of the racing vehicle RC from the vehicle speed sensor 38. In other words, the traveling data acquiring unit 34 functions as a vehicle speed acquisition section.

The traveling data acquiring unit 34 acquires driving data from the vehicle sensor 36 over time. The acquired travel data is stored in the memory 40 described below.

The memory 40 comprises an SSD (Solid State Drive), eMMC (embedded Multi Media Card), ROM (Read Only Memory), or RAM (Random Access Memory). As described above, the memory 40 stores the vehicle position information acquired by the vehicle position acquiring unit 32 and the driving data acquired by the traveling data acquiring unit 34. Also stored in the memory 40 is a judgment program for operating the various parts of the judging device 16. The judgment program can be stored in a computer-readable non-transitory storage medium, such as a USB (Universal Serial Bus) memory or an SD card, for example. The judging device 16 can read and execute the judgment program from such a storage medium.

The processor 42 comprises, for example, a central processing unit (CPU). The processor 42 is communicatively connected to the communication interface 30, the vehicle position acquiring unit 32, the traveling data acquiring unit 34, and the memory 40 via a data bus. The processor 42 functions as the race start preparation judging unit 44, the race start judging unit 46, the travel data recording unit 48, the race end judging unit 50, and the notification processing unit 52, according to the judgment program stored in the memory 40.

The race start preparation judging unit 44 judges whether or not the racing vehicle RC has stopped at the race start position and is ready to start the race before the start of the race in which the racing vehicle RC participates.

First, the race start preparation judging unit 44 identifies the course to be run in the race in which the racing vehicle RC participates from among the plurality of courses included in the course information 22 (see FIG. 2). This can be done based on a comparison of the driving route obtained based on the plurality of vehicle position information obtained by the vehicle position acquiring unit 32 when the racing vehicle RC drove on the said course in a practice run or the like before the race starts, and the position information indicating the layout of each course, which the course information 22 has. Alternatively, the course may be specified by the driver of the racing vehicle RC or other driver prior to the start of the race. Once the course to be run in the race in which the racing vehicle RC participates is identified, the race start preparation judging unit 44 identifies the start line, finish line, and the location of each grid for the course based on the course information 22.

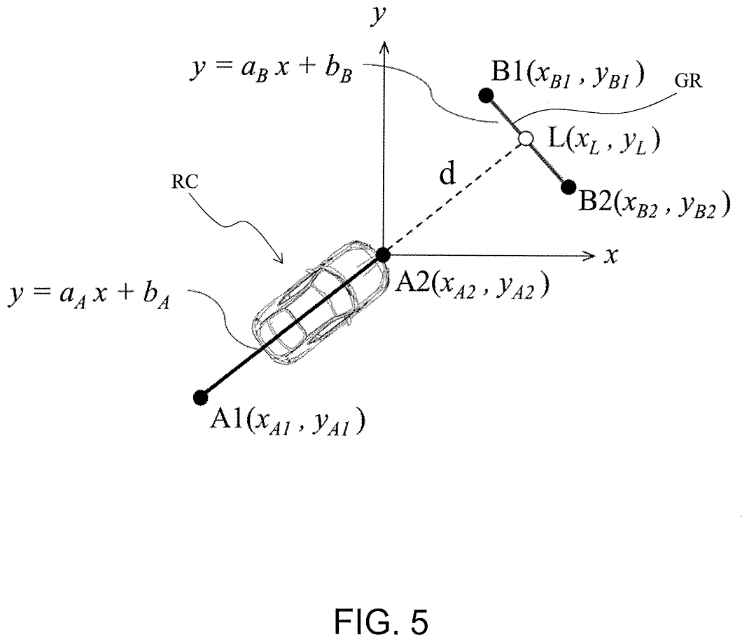

Next, the race start preparation judging unit 44 detects that the racing vehicle RC is within a predetermined range from the race start position. Referring to FIG. 5, the details of said detection process by the race start preparation judging unit 44 will be explained. It is assumed that information indicating which grid GR is the race start judging position of the racing vehicle RC (e.g., the result of the qualifying race) has been input to the judging device 16 in advance. The grid GR, which is the race start position of the racing vehicle RC, will hereinafter be referred to simply as grid GR. In the following description, the antenna of the vehicle position acquiring unit 32 is provided at the front end of the vehicle of the racing vehicle RC, and the vehicle position of the racing vehicle RC shall be referred to as the position of the front end of the vehicle of the racing vehicle RC.

First, the race start preparation judging unit 44 converts the two polar coordinates indicating the positions of one end and the other end of the grid GR into Cartesian coordinates (xyz coordinates). The conversion to Cartesian coordinates can be performed using known methods (e.g., “GPS Theory and Applications,” B. Hoffman-Wellenhoff, H. Lichtenegger, J. Collins, Springer-Verlag Tokyo, p. 319), so a detailed explanation is omitted here. Similarly, the race start preparation judging unit 44 also converts the polar coordinates indicating the vehicle position of the racing vehicle RC to Cartesian coordinates.

In FIG. 5, the vehicle position of the racing vehicle RC is represented by the Cartesian coordinates A1 (X_{A1},y_{A1}) and A2 (X_{A2},y_{A2}), one end of the grid GR is represented by the Cartesian coordinates B1 (X_{B1},y_{B1}) and the other end of the grid GR is represented by the Cartesian coordinates B2 (X_{B2},y_{B2}). A2 is the current position of the racing vehicle RC, and A1 represents the position of the racing vehicle RC in the past. In the example shown in FIG. 5, the z-axis coordinates of each position are omitted for convenience.

The race start preparation judging unit 44 determines the distance d between the front end of the racing vehicle RC and the grid GR as follows. First, the line segment A connecting A1 and A2 (i.e., the most recently traveled track of the racing vehicle RC) and the line segment B connecting B1 and B2 (i.e., the grid GR) can be expressed by the following equations (1) and (2).

$$y = {a}_{A} x + {b}_{A} \qquad ( 1 )$$

$$y = {a}_{B} x + {b}_{B} \qquad ( 2 )$$

If the vehicle position A2 of the racing vehicle RC at the present time is the origin of the Cartesian coordinates, b_{A}=0. Therefore, Equation (1) becomes Equation (1)′.

$$y = {a}_{A} x \qquad {( 1 )}^{′}$$

Here, the slope as of line segment A and the slope ap of line segment B are as in equations (3) and (4), respectively.

$${a}_{A} = \frac{{y}_{A 2} - {y}_{A 1}}{{x}_{A 2} - {x}_{A 1}} \qquad ( 3 )$$

$${a}_{B} = \frac{{y}_{B 2} - {y}_{B 1}}{{x}_{B 2} - {x}_{B 1}} \qquad ( 4 )$$

A variation of equation (2) yields equation (5).

$${b}_{B} = y - {a}_{B} x \qquad ( 5 )$$

At the intersection L (X_{L},y_{L}) between the extension of line A and line B, the relationship between equation (1)′ and equation (2) is as in equation (6) below.

$${a}_{A} x = {a}_{B} x + {b}_{B} \qquad ( 6 )$$

Therefore, the x-coordinate X_{L} of the intersection point L is expressed by Equation (7), and by substituting Equation (7) into Equation (1)′, the y-coordinate y_{L} of the intersection point L is expressed by Equation (8).

$${x}_{L} = \frac{{b}_{B}}{{a}_{A} - {a}_{B}} \qquad ( 7 )$$

$${y}_{L} = {a}_{A} \frac{{b}_{B}}{{a}_{A} - {a}_{B}} \qquad ( 8 )$$

By the Pythagorean theorem, the distance d between the racing vehicle RC's vehicle position and the grid GR is expressed by Equation (9).

$$d = \sqrt{{x}_{L}^{2} + {y}_{L}^{2}} \qquad ( 9 )$$

From equations (7), (8), and (9), the distance d can be expressed as a_{A}, b_{A}, a_{B}, and b_{B}. From equations (3), (4), and (5), a_{A},a_{B}, and b_{B} can be expressed as X_{A1},y_{A1},X_{A2}, y_{A2},X_{B1},y_{B1},X_{B2}, and y_{B2}. In other words, the distance d can be calculated based on the position information of one end and the other end of the grid GR and the vehicle position information of the racing vehicle RC.

When the calculated distance d is less than a predetermined distance threshold (e.g., 2 m), the race start preparation judging unit 44 detects that the racing vehicle RC is within a predetermined range from the grid GR, which is the race start position (in other words, the race vehicle RC is in the vicinity of the grid GR).

Furthermore, the race start preparation judging unit 44 detects that the racing vehicle RC is stopped based on the vehicle speed information obtained by the traveling data acquiring unit 34. In consideration of an error, the race start preparation judging unit 44 may detect that the racing vehicle RC is stopped by the fact that the vehicle speed of the racing vehicle RC is less than a predetermined first vehicle speed threshold (e.g., 1 km/h).

The race start preparation judging unit 44 judges that the racing vehicle RC has stopped at the race start position and the racing vehicle RC is ready to start racing when it detects that the racing vehicle RC is within the predetermined range from the race start position and the racing vehicle RC has stopped.

After the race start preparation judging unit 44 judges that the racing vehicle RC is ready to start a race, the race start judging unit 46 detects that the racing vehicle RC has departed based on the vehicle position information acquired by the vehicle position acquiring unit 32. In this embodiment, the race start judging unit 46 detects that the racing vehicle RC has departed when the vehicle speed of the racing vehicle RC reaches or exceeds the predetermined second vehicle speed threshold (e.g., 1 km/h). The first vehicle speed threshold and the second vehicle speed threshold may be the same or different.

The race start judging unit 46 judges that a race in which the racing vehicle RC participates has started when it detects that the racing vehicle RC has departed after the racing vehicle RC is ready to start the race. For example, the race start judging unit 46 identifies the point of departure of the racing vehicle RC after the racing vehicle RC is ready to start the race as the point of start of the race.

In this embodiment, the race start judging unit 46 determines that a race has started when it detects that the racing vehicle RC has departed after the race start preparation judging unit 44 judges that the racing vehicle RC is ready to start a race, but the race start judging unit 46 However, the race start judging unit 46 may judge the start of a race without relying on the judgment of the race start preparation judging unit 44. In this case, the race start judging unit 46 judges that a race has started when it detects that the racing vehicle RC has departed from the vicinity of the race start position based on the race start position information identified in the course information 22, the vehicle position information of the racing vehicle RC, and the vehicle speed information obtained by the traveling data acquiring unit 34. The race is judged to have started.

In this case, the race start judging unit 46 first detects that the racing vehicle RC has departed based on the vehicle position information acquired by the vehicle position acquiring unit 32. Then, by the same method described with reference to FIG. 5, based on the vehicle positions of the racing vehicle RC (A1 and A2 in FIG. 5) immediately after the racing vehicle RC has departed and the race start position information (B1 and B2 in FIG. 5), the race start judging unit 46 determines whether the The race start judging unit 46 judges whether or not the racing vehicle RC's position when the racing vehicle RC starts is within a predetermined range from the race start position. Then, the race start judging unit 46 detects that the racing vehicle RC has departed from the vicinity of the race start position and judges that the race has started when the vehicle position of the racing vehicle RC at the time the racing vehicle RC departed was within the predetermined range from the race start position.

As described above, according to this embodiment, since the race start judging device 16 judges the start of a race, it is possible to judge the start of a race without using a system provided at a circuit. In other words, it is possible to judge the start of a race at low cost. In particular, in this embodiment, the start of a race is not judged simply when the racing vehicle RC is detected to have departed after stopping, but when the racing vehicle RC is detected to have departed from the vicinity of the race start position. This means that if, for example, a race vehicle RC is performing a start practice in which the race vehicle RC is stopped and started during a formation lap (the race vehicle RC travels around the course to get to the grid GR), when the race vehicle RC starts during the start practice, the start of the race is judged to have started. The system prevents judging that the race has started when the race vehicle RC has started during the start practice.

According to this embodiment, the judging device 16 can easily determine that the racing vehicle RC is ready to start racing.

When the race is judged by the race start judging unit 46 to have started, the travel data recording unit 48 starts recording various driving data acquired by the traveling data acquiring unit 34 into the memory 40 from the time the race starts. For example, the travel data recording unit 48 starts recording images recorded by the on-board camera, measured travel times, data indicating the amount or timing of gas pedal and brake operations during the race, or data indicating handling operations, etc.

When the course run by a racing vehicle RC in a race in which the racing vehicle RC participates is a circuit course, the end-of-race judging unit 50 judges that the race has ended when it detects that the racing vehicle RC has run a predetermined number of laps based on the traveling route obtained based on the multiple vehicle position information obtained by the vehicle position acquiring unit 32. The race is judged to be over. When the course traveled by the racing vehicle RC in a race in which the racing vehicle RC participates is a non-loop course, the end-of-race judging unit 50 judges that the race has ended when it detects that the racing vehicle RC has crossed the goal line GL based on the vehicle position information of the racing vehicle RC and the position information indicating the position of the goal line GL contained in the course information 22 The race is judged to have ended when the race vehicle RC is detected to have crossed the goal line GL.

The notification processing unit 52 notifies the user of various driving data recorded by the travel data recording unit 48 after the race has started. For example, the notification processing unit 52 transmits the various driving data to the user terminal 12. The notification processing unit 52 may transmit the various running data to the user terminal 12 in real time as the travel data recording unit 48 begins recording the running data.

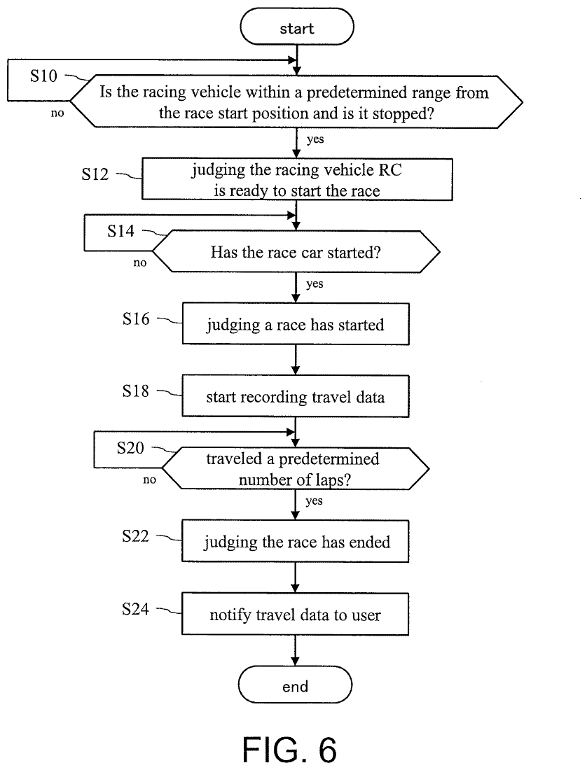

The outline of this form of judging device 16 is described above. The flowchart shown in FIG. 6 below describes the process flow of the judging device 16 in this embodiment.

In step S10, the race start preparation judging unit 44 judges whether the racing vehicle RC is within a predetermined range from the race start position and whether the racing vehicle RC is stopped. If the race start preparation judging unit 44 detects that the racing vehicle RC is within the predetermined range from the race start position and that the racing vehicle RC has stopped, it proceeds to step S12.

In step S12, the race start preparation judging unit 44 judges that the racing vehicle RC is ready to start the race.

In step S14, the race start judging unit 46 judges whether or not the racing vehicle RC has departed based on the vehicle position information obtained by the vehicle position acquiring unit 32. If the race start judging unit 46 detects that the racing vehicle RC has departed, it proceeds to step S16.

In step S16, the race start judging unit 46 judges that a race in which the racing vehicle RC participates has started.

In step S18, the travel data recording unit 48 starts recording various driving data acquired by the traveling data acquiring unit 34 into the memory 40.

In step S20, the end-of-race judging unit 50 judges whether or not the racing vehicle RC has traveled a predetermined number of laps based on the traveling route obtained based on the plurality of vehicle position information acquired by the vehicle position acquiring unit 32. If it is judged that the racing vehicle RC has traveled the predetermined number of laps, the unit proceeds to step S22.

In step S22, the race end judging unit 50 judges that the race has ended.

In step S24, the notification processing unit 52 transmits the various running data that was started to be recorded in step S18 to the user terminal 12.

The race start judging device and race start preparation judging device of the present disclosure are not limited to the above embodiments, but can be modified in various ways without departing from the intent thereof.

In this embodiment, the judging device 16 is a device provided in the racing vehicle RC, but the judging device 16 may be a portable terminal (e.g., a smartphone) brought into the racing vehicle RC.

In this embodiment, the vehicle speed of the racing vehicle RC was obtained by the vehicle speed sensor 38, but the vehicle speed of the racing vehicle RC may be obtained based on radio waves from a GNSS satellite obtained by the vehicle position acquiring unit 32. Specifically, the vehicle speed of the racing vehicle RC may be acquired based on the frequency transition caused by the Doppler effect due to the movement of the racing vehicle RC, which occurs in the radio waves output from the GNSS satellite.

### REFERENCE SIGNS LIST

10 judging system, 12 user terminal, 14 racing course server, 16 judging device, 22 course informan, 30 communication interface, 32 vehicle position acquiring unit, 34 traveling data acquiring unit, 36 vehicle sensor, 38 speed sensor, 40 memory, 42 processor, 44 race start preparation judging unit, 46 race start judging unit, 48 travel data recording unit, 50 end-of-race judging unit, 52 notification processing unit.

1. A race start judging device comprising:
a vehicle position acquiring unit that acquires vehicle position information indicating a position of a racing vehicle participating in a race;
a vehicle speed acquiring unit that acquires vehicle speed information indicating a vehicle speed of the racing vehicle; and
a race start judging unit that judges that the race has started upon detecting that the racing vehicle has departed from a vicinity of a race start position based on race start position information indicating the race start position at which the racing vehicle is to start the race, the vehicle position information, and the vehicle speed information.

2. The race start judging device according to claim 1, further comprising:
a race start preparation judging unit that judges that the racing vehicle is prepared to start a race upon detecting that the racing vehicle is within a predetermined range from the race start position based on the race start position information and the vehicle position information, and upon further detecting that the racing vehicle is stopped based on the vehicle speed information,
wherein the race start judging unit judges that the race has started upon detecting, based on the vehicle speed information, that the racing vehicle has departed, after the race start preparation judging unit judges that the racing vehicle is prepared to start the race.

3. A race start preparation judging device comprising:
a vehicle position acquiring unit that acquires vehicle position information indicating a position of a racing vehicle participating in a race;
a vehicle speed acquiring unit that acquires vehicle speed information indicating s vehicle speed of the racing vehicle; and
a race start preparation judging unit that judges that the racing vehicle is prepared to start a race upon detecting that the racing vehicle is within a predetermined range from a race start position based on race start position information indicating the race start position at which the racing vehicle is to start the race and the vehicle position information, and upon further detecting that the racing vehicle is stopped based on the vehicle speed information.
